(19) United States
(12) Patent Application Publication
(10) Pub. No.: US 2014/0002421 A1
(43) Pub. Date: Jan. 2, 2014

(54) USER INTERFACE DEVICE FOR PROJECTION COMPUTER AND INTERFACE METHOD USING THE SAME

(71) Applicant: Electronics And Telecommunications Research Institute, Daejeon (KR)

(72) Inventors: Dong-Woo LEE, Daejeon (KR); Hyun-Tae JEONG, Daejeon (KR); Gi-Su HEO, Jeonju (KR); Jun-Seok PARK, Daejeon (KR)

(21) Appl. No.: 13/917,006

(22) Filed: Jun. 13, 2013

(30) Foreign Application Priority Data
Jul. 2, 2012 (KR) 10-2012-0071660

(51) Int. Cl. G06F 3/0354

(52) U.S. Cl. CPC G06F 3/03545
USPC 345/179

(57) ABSTRACT

Disclosed herein is a user interface device for a projection computer and an interface method using the user interface device, which provides interaction between a user and the projection computer that outputs results by means of a projector, by using a hand and an infrared pen on the projection computer. The user interface device for a projection computer includes a projector unit for outputting results of the projection computer. A pattern light generation unit outputs infrared pattern light to a result output area to which the results are output. A camera unit obtains an image by capturing the result output area An image processing unit recognizes at least one of a user's hand and an infrared pen based on the image obtained by the camera unit. A control unit controls the pattern light generation unit, the camera unit, and the image processing unit based on a recognition mode.

### CROSS REFERENCE TO RELATEDED APPLICATION

This application claims the benefit of Korean Patent Application No. 10-2012-0071660, filed on Jul. 2, 2012, which is hereby incorporated by reference in its entirety into this application.

### BACKGROUND OF THE INVENTION

1. Technical Field

The present invention relates generally to a user interface device for a projection computer and an interface method using the user interface device and, more particularly, to a user interface device for a projection computer and an interface method using the user interface device, which provides natural input via a projection computer that outputs results using a projector. That is, the projection computer has been widely used in mixed reality and augmented reality thanks to the advantage of directly projecting images onto an actual object or the like and being able to mix analog information with digital information. When a mixed reality service, an augmented reality service, etc. are provided using such a projection computer, a means for processing the input of a user is required, so that the present invention relates to a method for making natural input in a system that uses the output of an image as a projector image.

2. Description of the Related Art

As revealed in the Light Touch system of Light Blue Optics and in SixthSense projector of MIT, a projection computer is a computer that outputs results using a projector. Since such a projection computer uses the projector to output results, it is advantageous in that images can be projected onto a place, such as a table or a wall surface, an actual object or the palm of the hand. Owing to this advantage, the projection computer is used for systems that provide a mixed reality service, an augmented reality service, etc.

Users greatly feel convenient with and become accustomed to user interfaces that use their hands on a mobile phone or a tablet equipped with a touch pad that employs a Liquid Crystal Display (LCD) as an output device.

Recently, in applications requiring a delicate task, the precision of a task using a finger is deteriorated, and thus pens usable in a tablet have been developed and released so that a delicate task can be performed on the tablet. However, as touch pads, a resistance-type touch pad and a capacitance-type touch pad are mainly mounted. Such a touch pad is disadvantageous in that when a user uses a pen to prevent bad entry, a task must be performed with the hand raised or with the glove on the hand so that a body region other than the end point of the pen does not come into contact with the touch pad.

Projection computers have been developed in various types, such as a table fixing type or a wearing type according to the usage environment of a system. In order to maximize the usability of the projection computer, the development of input technology capable of conveniently interacting with projector images is required.

For example, Korean Patent No. 10-1019141 (entitled “Electronic pen”) discloses a technology in which an image sensor is contained in an electronic pen, a code indicated on a specially produced writing target to track the trajectory of the pen is obtained by the image sensor of the pen, and the code is image-processed, thus enabling the trajectory to be tracked.

However, the prior technology relates to an input device using the tracking of the trajectory of the electronic pen, and is problematic in that both the hand and the pen cannot be simultaneously used, and a complicated structure, such as the image sensor, is formed in the electronic pen.

Further, the projection computer generally enables user interaction based on image processing using a camera. However, such a projection computer is problematic in that it is difficult to perform image processing because of serious variations in brightness and color occurring due to images of the projector, and in that complicated computations are performed, with the result that high-specification computing power is required.

### SUMMARY OF THE INVENTION

Accordingly, the present invention has been made keeping in mind the above problems occurring in the prior art, and an object of the present invention is to provide a user interface device for a projection computer and an interface method using the user interface device, which provide interaction between a user and the projection computer that outputs results by means of a projector, by using a hand and an infrared pen on the projection computer. That is, it is profitable for a user to use his or her hand from various aspects so as to intuitively and conveniently use output projector images even in the case of the projection computer, and there is a need to input information using a device, such as a pen familiar to the user, other than a finger, so as to perform a delicate task Therefore, the object of the present invention is to provide a user interface device for a projection computer and an interface method using the user interface device, which can provide the same convenience of use as that obtained when a task is performed with an existing pencil or ball-point pen upon performing a task with a pen even in the case of a projection computer in which an input sensing device, such as a touch pad, is not located on the bottom.

Another object of the present invention is to provide a user interface device for a projection computer and an interface method using the user interface device, which enable a pen to be used, together with an infrared pattern light generation device that is especially designed to enable low computation, so as to recognize a hand using a camera, thus improving the convenience of use by implementing a configuration in which both the pen and the hand can be used compared to the conventional technology in which only the pen is used under a projector image, or only the hand is used on the projector image.

In accordance with an aspect of the present invention to accomplish the above objects, there is provided a user interface device for a projection computer, including a projector unit for outputting results of the projection computer; a pattern light generation unit for outputting infrared pattern light to a result output area to which the results are output; a camera unit for obtaining an image by capturing the result output area; an image processing unit for recognizing at least one of a user's hand and an infrared pen based on the image obtained by the camera unit; and a control unit for controlling the pattern light generation unit, the camera unit, and the image processing unit based on a recognition mode.

Preferably, the user interface device may further include a synchronization unit for controlling output of the infrared pattern light from the pattern light generation unit based on whether a vertical synchronizing signal has been received from the camera unit, thus synchronizing the camera unit with the pattern light generation unit

Preferably, the control unit may be configured to, when a hand recognition mode is set, control the pattern light generation unit so that the infrared pattern light is output to the result output area, and thereafter control the camera unit so that the result output area to which the infrared pattern light is output is captured.

Preferably, the image processing unit may recognize the user's hand based on variations in the infrared pattern light appearing in the image obtained by capturing the result output area to which the infrared pattern light is output

Preferably, the control unit may be configured to, when a pen recognition mode is set, control the pattern light generation unit so that output of the infrared pattern light to the result output area is interrupted, and thereafter control the camera unit so that the result output area to which the infrared pattern light is not output is captured.

Preferably, the image processing unit may recognize a trajectory of infrared light, emitted from the infrared pen, from the image obtained by capturing the result output area to which the infrared pattern light is not output.

Preferably, the control unit may be configured to, when a hand and pen simultaneous recognition mode is set, control the pattern light generation unit so that the infrared pattern light is output to the result output area, and thereafter control the camera unit so that the result output area to which the infrared pattern light is output is captured, and control the pattern light generation unit so that output of the infrared pattern light to the result output area is interrupted, and thereafter control the camera unit so that the result output area to which the infrared pattern light is not output is captured.

Preferably, the image processing unit may be configured to extract and recognize both hands of the user based on variations in the pattern light appearing in an infrared image captured in a state in which the infrared pattern light is being output, recognize an end point of the infrared pen from an image captured in a state in which the infrared pattern light is not being output, and simultaneously recognize a posture of a hand that is not holding the infrared pen and a trajectory of the infrared pen by eliminating an area of a hand that is holding the infrared pen, from the recognized hands of the user based on the recognized end point of the pen.

Preferably, the image processing unit may include a hand recognition module for extracting an area of the hand from an image including the infrared pattern light; and a pen recognition module for extracting an end point of the infrared pen from an image in which the infrared pattern light is turned off.

Preferably, the image processing unit may generate an input event based on results of the recognition of the user's hand and/or the infrared pen.

In accordance with another aspect of the present invention to accomplish the above objects, there is provided an infrared pen for a user interface device for a projection computer, including a battery inserted into a housing of the infrared pen and configured to supply driving power; an infrared light emission unit arranged at an end point of the infrared pen and driven by the driving power to emit infrared light to an outside; and a spring connected at a first end to the battery and at a second end to the infrared light emission unit and configured to supply the driving power from the battery to the infrared light emission unit.

Preferably, the infrared light emission unit may be configured to, if the infrared pen is pressed, be connected to the battery via the spring and be supplied with the driving power.

In accordance with a further aspect of the present invention to accomplish the above objects, there is provided an interface method using a user interface device for a projection computer, including setting, by the user interface device for the projection computer, a recognition mode; outputting, by the user interface device for the projection computer, results of the projection computer; recognizing, by the user interface device for the projection computer, at least one of a user's hand and an infrared pen depending on the set recognition mode; and inputting, by the user interface device for the projection computer, an input event based on results of the recognition at the recognizing to the projection computer.

Preferably, the recognizing may include outputting, by a pattern light generation unit, infrared pattern light to a result output area when a hand recognition mode is set; and obtaining, by a camera unit, an image by capturing the result output area after the infrared pattern light has been output

Preferably, the recognizing may further include recognizing, by an image processing unit, the user's hand based on variations in the infrared pattern light appearing in the obtained image.

Preferably, the recognizing may include interrupting, by a pattern light generation unit, output of infrared pattern light to a result output area when a pen recognition mode is set; and obtaining, by a camera unit, an image by capturing the result output area after the output of the pattern light has been interrupted.

Preferably, the interface method may further include recognizing, by an image processing unit, a trajectory of infrared light emitted from the infrared pen from the obtained image.

Preferably, the recognizing may include outputting, by a pattern light generation unit, infrared pattern light to a result output area when a hand and pen simultaneous recognition mode is set; obtaining, by a camera unit, an image by capturing the result output area after the infrared pattern light has been output; interrupting, by the pattern light generation unit that received a vertical synchronizing signal from the camera unit, output of the infrared pattern light to the result output area; obtaining, by the camera unit, an image by capturing the result output area after the output of the pattern light has been interrupted; and recognizing the user's hand and the infrared pen based on the obtained images.

Preferably, the recognizing the user's hand and the pen may include extracting, by an image processing unit, both hands of the user based on variations in the pattern light appearing in the image captured in a state in which the infrared pattern light is being output; recognizing, by the image processing unit, an end point of the infrared pen from the image captured in a state in which the infrared pattern light is not being output; eliminating, by the image processing unit, an area of a hand that is holding the infrared pen, from the recognized hands of the user based on the recognized end point of the infrared pen; and simultaneously recognizing, by the image processing unit, a hand that is not holding the infrared pen and the infrared pen.

Preferably, the simultaneously recognizing the hand that is not holding the infrared pen and the infrared pen may be configured such that a posture of the hand and a trajectory of the infrared pen are simultaneously recognized by the image processing unit.

According to the present invention, the user interface device for the projection computer and the interface method using the user interface device are advantageous in that a user's hand is recognized based on variations in infrared pattern light output to a result output area, thus enabling the user's bare hand to be recognized using a low-computation structure.

Further, the user interface device for the projection computer and the interface method using the user interface device are advantageous in that variations in infrared pattern light and the trajectory of the infrared pen are recognized, thus enabling the user's bare hand and the pen to be simultaneously used.

Furthermore, the user interface device for the projection computer and the interface method using the user interface device can provide the convenience of use similar to that obtained when an existing pen is used because the pen can be used in the state in which the hand comes into direct contact with the bottom.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a user interface device for a projection computer according to an embodiment of the present invention;

FIG. 2 is a block diagram showing the configuration of a user interface device for a projection computer according to an embodiment of the present invention;

FIG. 3 is a diagram showing the pattern light generation unit of FIG. 2;

FIGS. 4 and 5 are diagrams showing the camera unit of FIG. 2;

FIG. 6 is a diagram showing the image processing unit of FIG. 2;

FIG. 7 is a diagram showing an infrared pen used in the user interface device for the projection computer according to an embodiment of the present invention;

FIG. 8 is a flowchart showing an interface method using the user interface device for the projection computer according to an embodiment of the present invention; and

FIGS. 9 to 11 are flowcharts showing the hand and infrared pen recognition mode step of FIG. 8.

### DESCRIPTION OF THE PREFERRED EMBODIMENTS

Preferred embodiments of the present invention will be described in detail below with reference to the accompanying drawings to such an extent that those skilled in the art can easily implement the technical spirit of the present invention. Reference now should be made to the drawings, in which the same reference numerals are used throughout the different drawings to designate the same or similar components. In the following description, redundant descriptions and detailed descriptions of known elements or functions that may unnecessarily make the gist of the present invention obscure will be omitted.

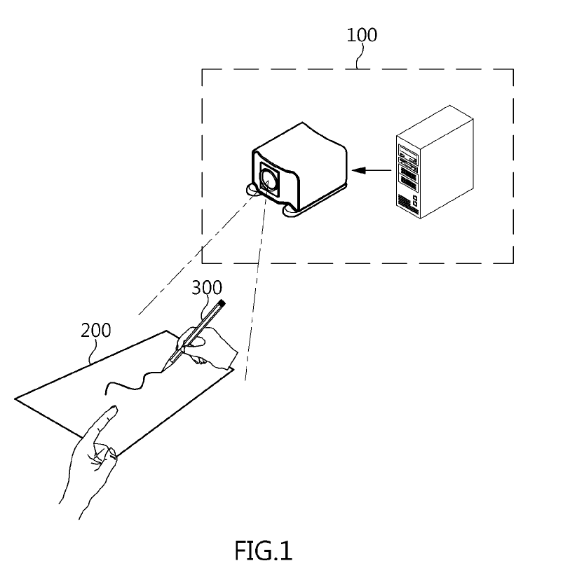

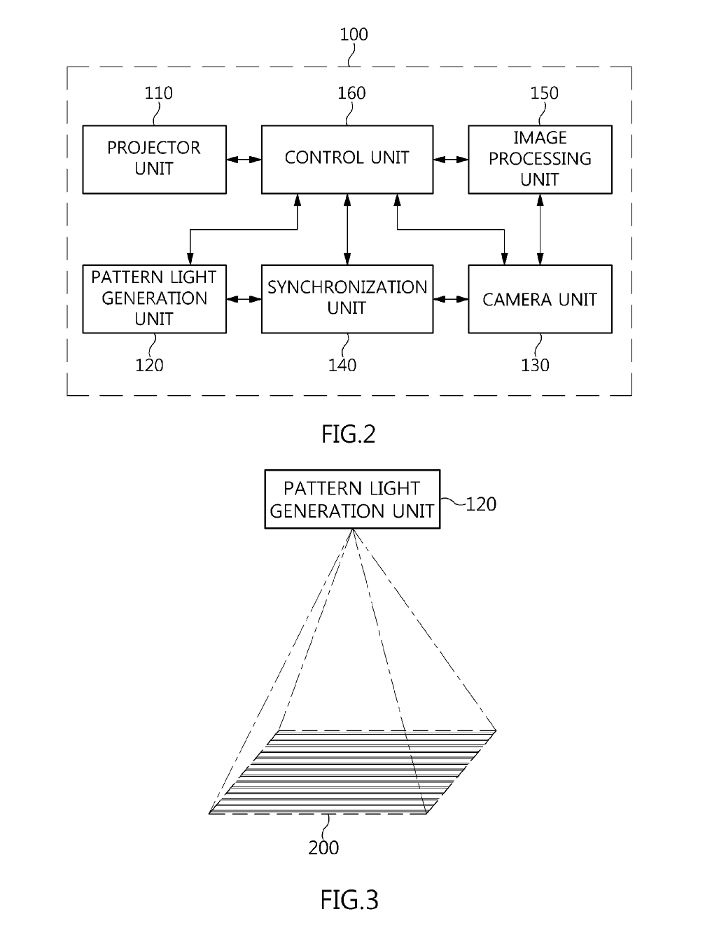

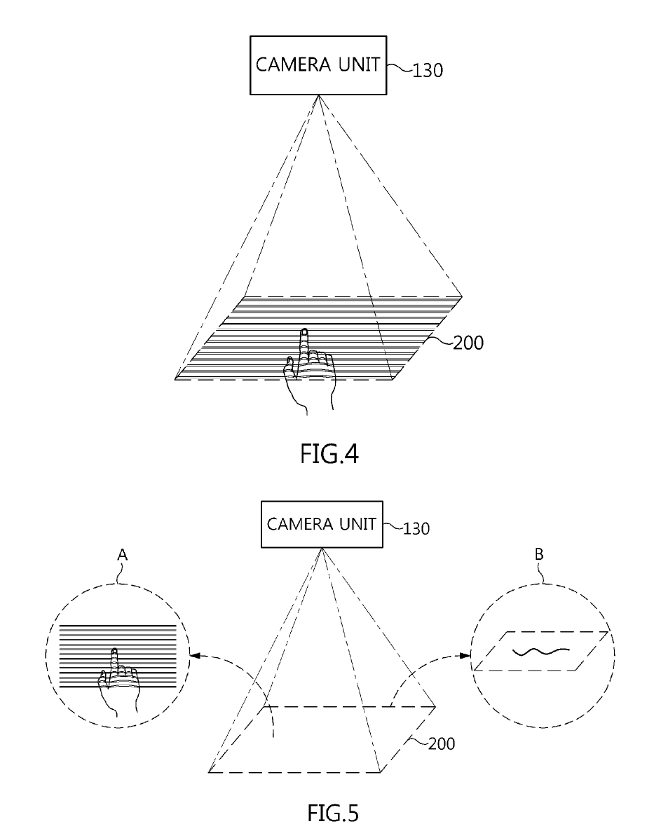

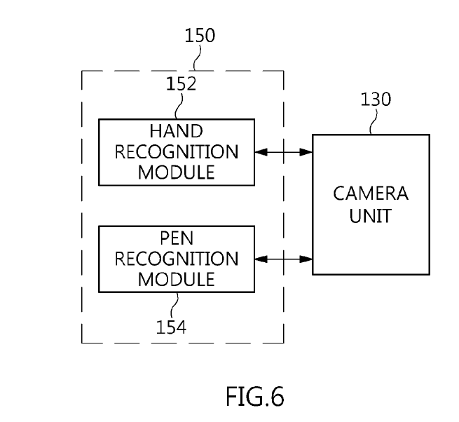

Hereinafter, a user interface device for a projection computer according to an embodiment of the present invention will be described in detail with reference to the attached drawings. FIG. 1 is a diagram showing a user interface device for a projection computer according to an embodiment of the present invention. FIG. 2 is a block diagram showing the configuration of a user interface device for a projection computer according to an embodiment of the present invention. FIG. 3 is a diagram showing the pattern light generation unit of FIG. 2. FIGS. 4 and 5 are diagrams showing the camera unit of FIG. 2. FIG. 6 is a diagram showing the image processing unit of FIG. 2.

As shown in FIG. 1, a user interface device 100 for a projection computer outputs results via a projector. The user interface device 100 for the projection computer performs image processing on an image obtained by capturing a result output area 200 using an infrared camera, and then individually recognizes a user's hand and an infrared pen 300. The user interface device 100 for the projection computer may also perform image processing on an image obtained by capturing the result output area 200 using the infrared camera, and then simultaneously recognize the user's hand and the trajectory of the infrared pen 300.

First, the case where only the user's hand is recognized is described below. The user interface device 100 for the projection computer outputs infrared pattern light to the result output area 200 so as to recognize the user's hand. The user interface device 100 for the projection computer captures an image of the result output area 200 using the infrared camera. In this case, the user interface device 100 for the projection computer performs image processing on the captured image, and then detects variations in pattern light. The user interface device 100 for the projection computer recognizes the user's hand by extracting the user's hand based on the previously detected variations in the pattern light.

Next, the case where only the trajectory of the infrared pen 300 is recognized is described below. The user interface device 100 for the projection computer captures the image of the result output area 200 using the infrared camera in a state in which infrared pattern light is not being output, in order to recognize the trajectory of the infrared pen 300. In this case, the user interface device 100 for the projection computer captures an infrared image output from the infrared pen 300. The user interface device 100 for the projection computer performs image processing on the captured image, and then recognizes the end point of the pen.

Finally, the case where both the user's hand and the trajectory of the infrared pen 300 are simultaneously recognized is described below. After the user interface device 100 for the projection computer has captured an image of the result output area 200 in a state in which the infrared pattern light is being output, it captures an image of the result output area 200 in a state in which infrared pattern light is not being output The user interface device 100 for the projection computer performs image processing on the image captured in the state in which the infrared pattern light is being output, and then detects variations in the pattern light. The user interface device 100 for the projection computer extracts and recognizes both hands of the user based on the previously detected variations in the pattern light. The user interface device 100 for the projection computer performs image processing on the image captured in the state in which the infrared pattern light is not being output, and then recognizes the end point of the pen. The user interface device 100 for the projection computer eliminates the area of the hand that is holding the infrared pen 300, from the recognized hands of the user based on the recognized end point of the pen. By means of this operation, the user interface device 100 for the projection computer simultaneously recognizes the posture of the hand that is not holding the infrared pen 300 and the trajectory of the infrared pen 300. In this case, the user interface device 100 for the projection computer generates various input events using the posture of the hand that is not holding the infrared pen 300 and the trajectory of the infrared pen 300.

For this operation, as shown in FIG. 2, the user interface device 100 for the projection computer includes a projector unit 110, a pattern light generation unit 120, a camera unit 130, a synchronization unit 140, an image processing unit 150, and a control unit 160.

The projector unit 110 outputs results. That is, the projector unit 110 is implemented as a projector, and outputs the results calculated by the projection computer via the projector.

The pattern light generation unit 120 outputs infrared pattern light having a specific pattern to the result output area 200 that is an area to which the results are output by the projector unit 110. That is, the pattern light generation unit 120 generates an artificial image pattern composed of points or lines helpful to image processing so as to rapidly and easily perform image processing and perform low-computational image processing. The pattern light generation unit 120 outputs infrared pattern light corresponding to the generated image pattern to the result output area 200 (see FIG. 3). In this case, the pattern light generation unit 120 receives a pattern light output control signal from the control unit 160, and outputs infrared pattern light to the result output area. When receiving a pattern light output limitation control signal from the synchronization unit 140 while outputting the infrared pattern light, the pattern light generation unit 120 stops outputting the infrared pattern light.

The camera unit 130 is implemented as an infrared camera and is configured to capture infrared images of the result output area 200. In this case, the camera unit 130 captures the infrared images of the result output area 200 in response to a control signal from the control unit 160.

The camera unit 130 captures an infrared image of the result output area 200 in the state in which the infrared pattern light is being output. That is, in order to obtain images used to recognize the user's hand, the camera unit 130 captures the result output area 200 when receiving a capturing control signal from the control unit 160 in the state in which the infrared pattern light is being output. In this case, as shown in FIG. 4, the image captured by the camera unit 130 is an image in which the infrared pattern light is varied by the user's hand. The camera unit 130 transmits the captured infrared images to the image processing unit

The camera unit 130 captures an infrared image of the result output area 200 in the state in which infrared light is being output from only the infrared pen 300 without the infrared pattern light being output. That is, in order to obtain images used to recognize the trajectory of the infrared pen 300, the camera unit 130 captures the result output area 200 when receiving a capturing control signal from the control unit 160 in the state in which the infrared pattern light is not being output. The camera unit 130 transmits the captured infrared images to the image processing unit.

After capturing the result output area 200 in the state in which infrared pattern light is being output, the camera unit 130 captures the result output area 200 in the state in which the infrared pattern light is not being output. That is, the camera unit 130 captures the result output area 200 in the state in which infrared pattern light is being output in response to the capturing control signal from the control unit 160 (A of FIG. 5). The camera unit 130 generates a vertical synchronizing signal in response to the capturing control signal from the control unit 160, and transmits the vertical synchronizing signal to the synchronization unit 140. The camera unit 130 captures the result output area 200 after the output of the infrared pattern light has been stopped in response to the vertical synchronizing signal (B of FIG. 5). The camera unit 130 transmits the captured infrared images to the image processing unit.

The synchronization unit 140 synchronizes the camera unit 130 with the pattern light generation unit 120. That is, the synchronization unit 140 functions to synchronize the camera unit 130 with the pattern light generation unit 120, and synchronizes the output of pattern light from the pattern light generation unit 120 based on whether the vertical synchronizing system VSYNC has been received from the camera unit 130. In this case, when receiving the vertical synchronizing signal from the camera unit 130, the synchronization unit 140 transmits a pattern light output limitation signal to the pattern light generation unit 120.

The image processing unit 150 extracts the user's hand and the trajectory of the infrared pen 300 from the infrared images captured by the camera unit 130. That is, the image processing unit performs image processing on image signals captured by the camera unit 130 and extracts the shape (posture) of the hand and the end point of a finger or the end point of the pen. The image processing unit 150 recognizes the user's hand based on variations in pattern light appearing in the infrared image captured in the state in which the infrared pattern light is being output. The image processing unit 150 performs image processing on the image captured in the state in which the infrared pattern light is not being output, and then recognizes the end point of the pen. The image processing unit 150 extracts and recognizes both hands of the user based on variations in the pattern light appearing in the infrared image captured in the state in which the infrared pattern light is being output. The image processing unit 150 performs image processing on the image captured in the state in which the infrared pattern light is not being output, and then recognizes the end point of the pen. The image processing unit 150 eliminates the area of the hand that is holding the infrared pen 300, from the recognized hands based on the recognized end point of the pen. By means of this, the image processing unit 150 simultaneously recognizes the posture of the hand that is not holding the infrared pen 300 and the trajectory of the infrared pen 300.

The image processing unit transmits the results of the image processing (that is, the posture of the hand, the end point of the finger, and the end point of the pen) to the projection computer as the input thereof. In this case, the image processing unit transmits basic mouse events, such as click, drag, and release events, as system input, and transmits input events, such as magnification, reduction, and deletion events, as input of the projection computer, using the posture of the hand and the trajectory of the end point of the pen.

For this operation, as shown in FIG. 6, the image processing unit 150 includes a hand recognition module 152 for extracting the area of the hand from an image including infrared pattern light, and a pen recognition module 154 for extracting the end point of the pen from an image in which the infrared pattern light is turned off. In this case, the image processing unit 150 may also extract the area of the hand that is holding the infrared pen 300 and the end point of the infrared pen 300 via the hand recognition module 152 and the pen recognition module 154.

The control unit 160 controls the projector unit 110, the pattern light generation unit 120, the camera unit 130, the synchronization unit 140, and the image processing unit 150 so as to recognize the user's hand and the infrared pen 300.

The control unit 160 controls the projector unit 110 so as to output the results of the projection computer. When the results are input from the projection computer, the control unit 160 transmits the corresponding results, together with a result output control signal, to the projector unit 110. Accordingly, the projector unit 110 outputs the results.

The control unit 160 controls the pattern light generation unit 120, the synchronization unit 140, and the camera unit 130 depending on the recognition mode.

In the mode in which only the user's hand is recognized, the control unit 160 transmits a pattern light output control signal to the pattern light generation unit 120. When the infrared pattern light is output to the result output area 200 by the pattern light generation unit 120, the control unit 160 transmits a capturing control signal to the camera unit 130, so that the result output area 200 to which the infrared pattern light is output is captured.

In the mode in which only the infrared pen 300 is recognized, the control unit 160 transmits a pattern light output limitation control signal to the pattern light generation unit 120. In the state in which the infrared pattern light is not being output to the result output area 200, the control unit 160 transmits the capturing control signal to the camera unit 130, and then controls the camera unit 130 so that the result output area 200 is captured.

In the case where the user's hand and the infrared pen 300 are simultaneously recognized, the control unit 160 transmits a pattern light output control signal to the pattern light generation unit 120. When the infrared pattern light is output to the result output area 200 by the pattern light generation unit 120, the control unit 160 transmits a capturing control signal to the camera unit 130, and then controls the camera unit 130 so that the result output area 200 to which the infrared pattern light is output is captured. The control unit 160 transmits the capturing control signal and a vertical synchronizing signal generation control signal to the camera unit 130, and then controls the camera unit 130 so that after the vertical synchronizing signal has been generated, the result output area 200 is captured.

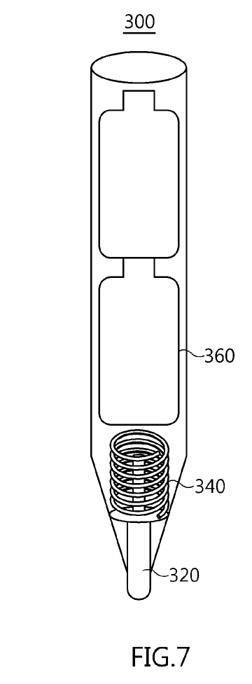

Hereinafter, an infrared pen used for the user interface device for the projection computer according to an embodiment of the present invention will be described in detail with reference to the attached drawings FIG. 7 is a diagram showing the infrared pen used for the user interface device for the projection computer according to an embodiment of the present invention.

As shown in FIG. 7, the infrared pen 300 is formed in the shape of a typically used pen. The infrared pen 300 is formed as a normal structure in which when the end point of the pen comes into contact with the bottom and then the pen is pressed so as to perform writing, infrared light is turned on, and in which when the pen is removed from the bottom, the infrared light is turned off. For this function, the infrared pen 300 includes an infrared light emission unit 320 for emitting infrared light to the outside of the pen, a spring 340 contracted by the infrared light emission unit 320 to connect a battery 360 to the infrared light emission unit 320, and the battery 360 for supplying driving power to the infrared light emission unit 320 via the spring 340.

The infrared light emission unit 320 is arranged at the end point of the infrared pen 300. The infrared light emission unit 320 is shorted to the battery 360 via the spring 340 and is then supplied with the driving power. That is, when the pen is pressed, the infrared light emission unit 320 is connected to the battery 360 via the spring 340 and is then supplied with the driving power from the battery 360. When the driving power is input, the infrared light emission unit 320 emits infrared light to the outside of the pen. Accordingly, when the pen is pressed, the infrared light emission unit 320 emits infrared light, whereas when the pen becomes removed from the bottom, it stops emitting infrared light

The infrared pen 300 can be naturally used as in the case of a typical pen by means of the above-described structure.

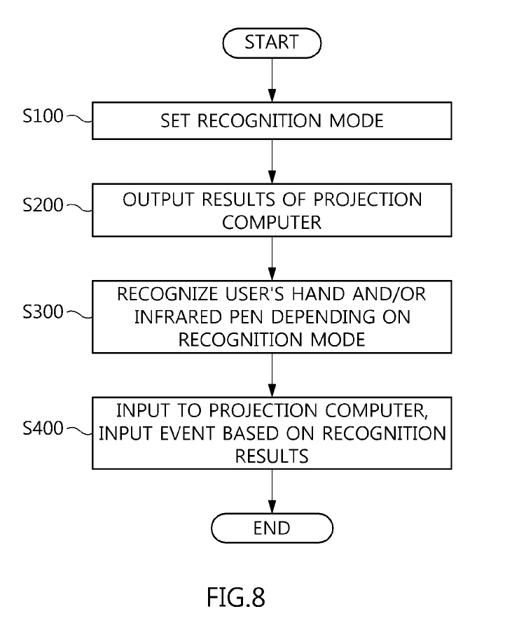

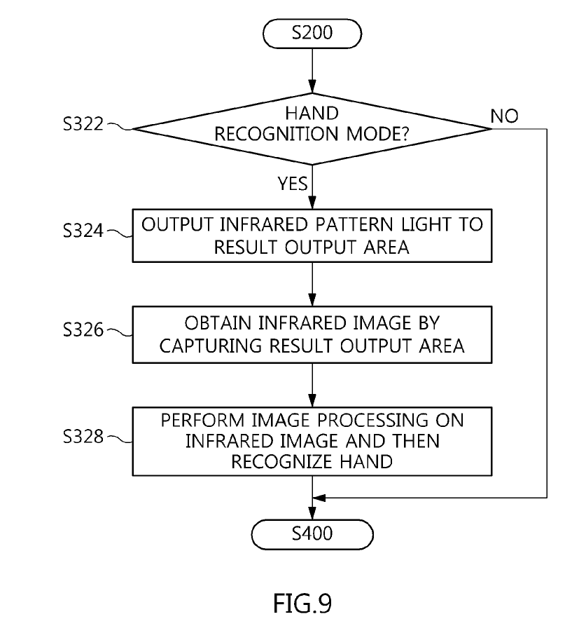

Hereinafter, an interface method using the user interface device for the projection computer according to an embodiment of the present invention will be described in detail with reference to the attached drawings FIG. 8 is a flowchart showing an interface method using the user interface device for the projection computer according to an embodiment of the present invention, and FIGS. 9 to 11 are flowcharts showing the hand and infrared pen recognition mode step of FIG. 8.

First, the user interface device 100 for the projection computer sets a recognition mode at step S100. That is, the user interface device 100 for the projection computer sets one of a hand recognition mode, a pen recognition mode, and a hand and pen simultaneous recognition mode. In this case, the user interface device 100 for the projection computer receives a recognition mode from a user. Of course, the user interface device 100 for the projection computer may omit the setting of the recognition mode, and may automatically set the recognition mode via a hand and/or infrared pen 300 recognition step which will be described later.

The user interface device 100 for the projection computer outputs the results of the projection computer at step S200. That is, when the results are input from the projection computer, the control unit 160 transmits the corresponding results, together with a result output control signal, to the projector unit 110. Accordingly, the projector unit 110 outputs the results.

The user interface device 100 for the projection computer recognizes the user's hand and/or the infrared pen 300 depending on the preset recognition mode at step S300. In this case, the user interface device 100 for the projection computer implements different methods of recognizing the user's hand and/or the infrared pen 300 depending on the recognition mode. This operation will be described in detail with reference to the attached drawings.

First, as shown in FIG. 9, when the hand recognition mode is set at step S322, the control unit 160 controls the pattern light generation unit 120, and then outputs infrared pattern light to the result output area 200 at step S324. That is, when the hand recognition mode in which only the user's hand is recognized is set, the control unit 160 transmits a pattern light output control signal to the pattern light generation unit 120. Accordingly, the pattern light generation unit 120 outputs infrared pattern light having a predetermined pattern to the result output area 200.

The control unit 160 controls the camera unit 130 and then obtains an infrared image of the result output area 200 to which the infrared pattern light is output at step S326. That is, the control unit 160 transmits a capturing control signal to the camera unit 130 and then controls the camera unit 130 so that the result output area 200 to which the infrared pattern light is output is captured. Accordingly, the camera unit 130 obtains the infrared image by capturing the result output area 200. The camera unit 130 transmits the obtained infrared image to the image processing unit 150.

The image processing unit 150 performs image processing on the obtained infrared image, and then recognizes the user's hand at step S328. That is, the image processing unit 150 extracts the user's hand from the infrared image captured by the camera unit 130. In this case, the image processing unit 150 extracts the posture of the hand and the end point of a finger.

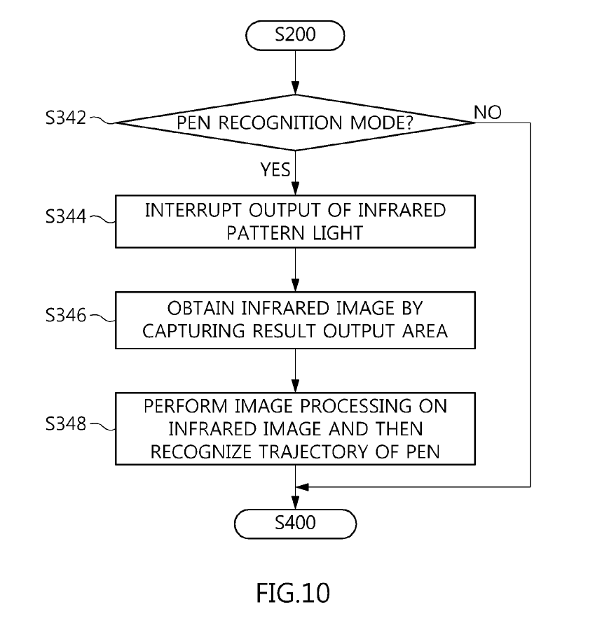

Next, as shown in FIG. 10, when the pen recognition mode is set at step S342, the control unit 160 controls the pattern light generation unit 120, so that the output of the infrared pattern light to the result output area 200 is interrupted at step S344. That is, when the pen recognition mode in which only the infrared pen 300 is recognized is set, the control unit 160 transmits a pattern light output limitation control signal to the pattern light generation unit 120. Accordingly, the pattern light generation unit 120 stops outputting the infrared pattern light to the result output area 200.

The control unit 160 controls the camera unit 130, and then obtains an infrared image of the result output area 200 in the state in which the infrared pattern light is not being output at step S346. That is, the control unit 160 transmits a capturing control signal to the camera unit 130, and then controls the camera unit 130 so that the result output area 200 is captured. Accordingly, the camera unit 130 captures an infrared image of the result output area 200 to which infrared pattern light is not output. The camera unit 130 transmits the obtained infrared image to the image processing unit 150.

The image processing unit 150 performs image processing on the obtained infrared image and then recognizes the trajectory of the infrared pen 300 at step S348. That is, the image processing unit 150 extracts the trajectory of infrared light emitted from the infrared pen 300 from the infrared image captured by the camera unit 130. Of course, the image processing unit 150 may also recognize the end point of the infrared pen 300 by means of the image processing of the infrared image.

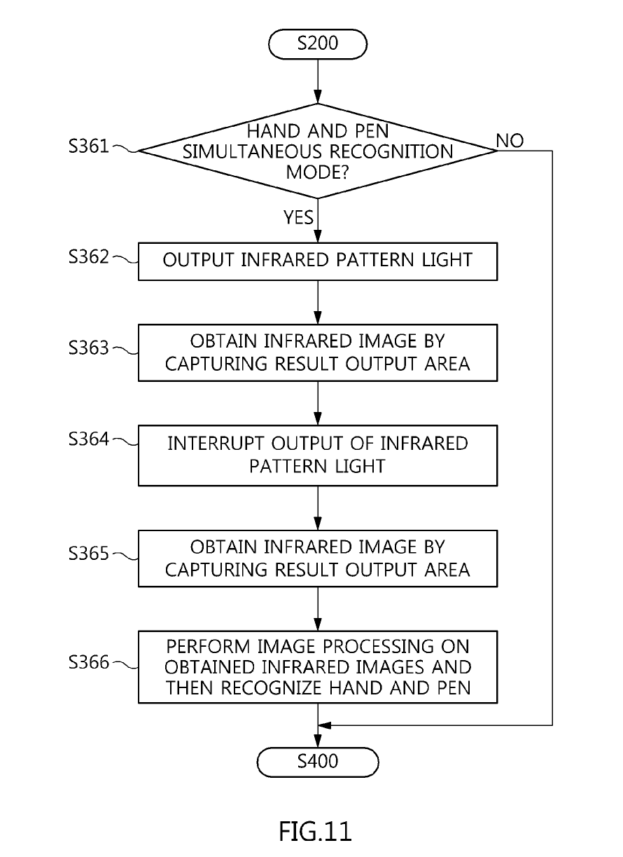

Finally, as shown in FIG. 11, when the hand and pen simultaneous recognition mode is set at step S361, the control unit 160 controls the pattern light generation unit 120, so that the infrared pattern light is output to the result output area 200 at step S362. That is, when the hand and pen simultaneous recognition mode in which both the user's hand and the pen are simultaneously recognized is set, the control unit 160 transmits a pattern light output control signal to the pattern light generation unit 120. Accordingly, the pattern light generation unit 120 outputs infrared pattern light having a predetermined pattern to the result output area 200.

The control unit 160 controls the camera unit 130 and then obtains an infrared image of the result output area 200 to which the infrared pattern light is output at step S363. That is, the control unit 160 transmits a capturing control signal to the camera unit 130, and then controls the camera unit 130 so that the result output area 200 to which the infrared pattern light is output is captured. Accordingly, the camera unit 130 obtains the infrared image by capturing the result output area 200. The camera unit 130 transmits the obtained infrared image to the image processing unit 150.

The control unit 160 controls the pattern light generation unit 120 so that the output of the infrared pattern light to the result output area 200 is interrupted at step S364. That is, the control unit 160 transmits a pattern light output limitation control signal to the pattern light generation unit 120. Accordingly, the pattern light generation unit 120 stops outputting the infrared pattern light to the result output area 200.

The control unit 160 controls the camera unit 130, so that an infrared image of the result output area 200 is obtained in the state in which infrared pattern light is not being output at step S365. That is, the control unit 160 transmits a capturing control signal to the camera unit 130, and then controls the camera unit 130 so that the result output area 200 is captured. Accordingly, the camera unit 130 captures an infrared image of the result output area 200 to which the infrared pattern light is not output. The camera unit 130 transmits the obtained infrared image to the image processing unit 150.

The image processing unit 150 recognizes the hand and the pen by performing image processing on the obtained infrared images at step S366. That is, the image processing unit 150 extracts and recognizes both hands of the user on the basis of variations in the pattern light appearing in the infrared image captured in the state in which infrared pattern light is being output The image processing unit 150 performs image processing on the image captured in the state in which the infrared pattern light is not being output, and then recognizes the end point of the pen. The image processing unit 150 eliminates the area of the hand that is holding the infrared pen 300, from the recognized hands of the user based on the recognized end point of the pen. By way of this operation, the image processing unit 150 simultaneously recognizes both the posture of the hand that is not holding the infrared pen 300 and the trajectory of the infrared pen 300.

The user interface device 100 for the projection computer inputs an input event based on the results of the recognition to the projection computer at step S400. The image processing unit of the user interface device 100 for the projection computer inputs various input events, such as a mouse event, to the projection computer, based on the results of the recognition of the user's hand and/or the infrared pen 300 at step S300. That is, the image processing unit transmits basic mouse events, such as click, drag, and release events, as system input, and transmits input events, such as magnification, reduction, and deletion events, as input of the projection computer, using the posture of the hand and the trajectory of the end point of the pen.

As described above, the user interface device for the projection computer and the interface method using the user interface device according to the present invention are advantageous in that a user's hand is recognized based on variations in infrared pattern light output to a result output area, thus enabling the user's bare hand to be recognized using a low-computation structure.

Further, the user interface device for the projection computer and the interface method using the user interface device are advantageous in that variations in infrared pattern light and the trajectory of the infrared pen are recognized, thus enabling the user's bare hand and the pen to be simultaneously used.

Furthermore, the user interface device for the projection computer and the interface method using the user interface device can provide the convenience of use similar to that obtained when an existing pen is used because the pen can be used in the state in which the hand comes into direct contact with the bottom.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A user interface device for a projection computer, comprising:
a projector unit for outputting results of the projection computer;
a pattern light generation unit for outputting infrared pattern light to a result output area to which the results are output;
a camera unit for obtaining an image by capturing the result output area;
an image processing unit for recognizing at least one of a user's hand and an infrared pen based on the image obtained by the camera unit; and
a control unit for controlling the pattern light generation unit, the camera unit, and the image processing unit based on a recognition mode.

2. The user interface device of claim 1, further comprising a synchronization unit for controlling output of the infrared pattern light from the pattern light generation unit based on whether a vertical synchronizing signal has been received from the camera unit, thus synchronizing the camera unit with the pattern light generation unit

3. The user interface device of claim 1, wherein the control unit is configured to, when a hand recognition mode is set, control the pattern light generation unit so that the infrared pattern light is output to the result output area, and thereafter control the camera unit so that the result output area to which the infrared pattern light is output is captured.

4. The user interface device of claim 3, wherein the image processing unit recognizes the user's hand based on variations in the infrared pattern light appearing in the image obtained by capturing the result output area to which the infrared pattern light is output

5. The user interface device of claim 1, wherein the control unit is configured to, when a pen recognition mode is set, control the pattern light generation unit so that output of the infrared pattern light to the result output area is interrupted, and thereafter control the camera unit so that the result output area to which the infrared pattern light is not output is captured.

6. The user interface device of claim 5, wherein the image processing unit recognizes a trajectory of infrared light, emitted from the infrared pen, from the image obtained by capturing the result output area to which the infrared pattern light is not output

7. The user interface device of claim 1, wherein the control unit is configured to, when a hand and pen simultaneous recognition mode is set,
control the pattern light generation unit so that the infrared pattern light is output to the result output area, and thereafter control the camera unit so that the result output area to which the infrared pattern light is output is captured, and
control the pattern light generation unit so that output of the infrared pattern light to the result output area is interrupted, and thereafter control the camera unit so that the result output area to which the infrared pattern light is not output is captured.

8. The user interface device of claim 7, wherein the image processing unit is configured to:
extract and recognize both hands of the user based on variations in the pattern light appearing in an infrared image captured in a state in which the infrared pattern light is being output,
recognize an end point of the infrared pen from an image captured in a state in which the infrared pattern light is not being output, and
simultaneously recognize a posture of a hand that is not holding the infrared pen and a trajectory of the infrared pen by eliminating an area of a hand that is holding the infrared pen, from the recognized hands of the user based on the recognized end point of the pen.

9. The user interface device of claim 1, wherein the image processing unit comprises:
a hand recognition module for extracting an area of the hand from an image including the infrared pattern light; and
a pen recognition module for extracting an end point of the infrared pen from an image in which the infrared pattern light is turned off.

10. The user interface device of claim 1, wherein the image processing unit generates an input event based on results of the recognition of the user's hand and/or the infrared pen.

11. An infrared pen for a user interface device for a projection computer, comprising:
a battery inserted into a housing of the infrared pen and configured to supply driving power;
an infrared light emission unit arranged at an end point of the infrared pen and driven by the driving power to emit infrared light to an outside; and
a spring connected at a first end to the battery and at a second end to the infrared light emission unit and configured to supply the driving power from the battery to the infrared light emission unit

12. The infrared pen of claim 11, wherein the infrared light emission unit is configured to, if the infrared pen is pressed, be connected to the battery via the spring and be supplied with the driving power.

13. An interface method using a user interface device for a projection computer, comprising:
setting, by the user interface device for the projection computer, a recognition mode;
outputting, by the user interface device for the projection computer, results of the projection computer;
recognizing, by the user interface device for the projection computer, at least one of a user's hand and an infrared pen depending on the set recognition mode; and
inputting, by the user interface device for the projection computer, an input event based on results of the recognition at the recognizing to the projection computer.

14. The interface method of claim 13, wherein the recognizing comprises:
outputting, by a pattern light generation unit, infrared pattern light to a result output area when a hand recognition mode is set; and
obtaining, by a camera unit, an image by capturing the result output area after the infrared pattern light has been output

15. The interface method of claim 14, wherein the recognizing further comprises:
recognizing, by an image processing unit, the user's hand based on variations in the infrared pattern light appearing in the obtained image.

16. The interface method of claim 13, wherein the recognizing comprises:
interrupting, by a pattern light generation unit, output of infrared pattern light to a result output area when a pen recognition mode is set; and
obtaining, by a camera unit, an image by capturing the result output area after the output of the pattern light has been interrupted.

17. The interface method of claim 16, further comprising:
recognizing, by an image processing unit, a trajectory of infrared light emitted from the infrared pen from the obtained image.

18. The interface method of claim 13, wherein the recognizing comprises:
outputting, by a pattern light generation unit, infrared pattern light to a result output area when a hand and pen simultaneous recognition mode is set;
obtaining, by a camera unit, an image by capturing the result output area after the infrared pattern light has been output;
interrupting, by the pattern light generation unit that received a vertical synchronizing signal from the camera unit, output of the infrared pattern light to the result output area;
obtaining, by the camera unit, an image by capturing the result output area after the output of the pattern light has been interrupted; and
recognizing the user's hand and the infrared pen based on the obtained images.

19. The interface method of claim 18, wherein the recognizing the user's hand and the pen comprise:
extracting, by an image processing unit, both hands of the user based on variations in the pattern light appearing in the image captured in a state in which the infrared pattern light is being output;
recognizing, by the image processing unit, an end point of the infrared pen from the image captured in a state in which the infrared pattern light is not being output;
eliminating, by the image processing unit, an area of a hand that is holding the infrared pen, from the recognized hands of the user based on the recognized end point of the infrared pen; and
simultaneously recognizing, by the image processing unit, a hand that is not holding the infrared pen and the infrared pen.

20. The user interface device of claim 19, wherein the simultaneously recognizing the hand that is not holding the infrared pen and the infrared pen is configured such that a posture of the hand and a trajectory of the infrared pen are simultaneously recognized by the image processing unit
